(19) United States
(12) Patent Application Publication
(10) Pub. No.: US 2023/0153860 A1
(43) Pub. Date: May 18, 2023

(54) COMPUTER SYSTEM FOR CAMPAIGN MEDIA AND METHODS OF OPERATING THE SAME

(71) Applicant: Rakuten Mobile, Inc., Tokyo (JP)

(72) Inventors: Dewa SISWANTO, Tokyo (JP); Rina TAKAMATSU, Tokyo (JP); Mami HARIYA, Tokyo (JP)

(21) Appl. No.: 17/455,403

(22) Filed: Nov. 17, 2021

(51) Int. Cl. G06Q 30/02

(52) U.S. Cl. CPC G06Q 30/0264; G06Q 30/0205; G06Q 30/0254

(57) ABSTRACT

Systems and methods of distributing campaign media are disclosed. In some embodiments, a campaign data structure is obtained related to campaign media. Additionally, audience data structures are obtained, wherein each of the audience data structures describes a corresponding audience of a plurality of audiences. Using a computer device, at least one target audience is selected for the campaign media from the plurality of audiences based on the campaign data structure and the audience data structures. Also using the computer device, one or more electronic transmissions of the campaign media are scheduled to at least one user device associated with the at least one target audience based on the campaign data structure and the audience data structures.

### BACKGROUND

Many advertising campaigns are now electronically distributed campaign media to end users. Campaign media include themes and messaging promoting ideas, products, or services to consumers. The goal is often to distribute the campaign media to interested consumers at the most opportune times.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a block diagram of an automated campaign system, in accordance with some embodiments.

FIG. 2 is a block diagram illustrating automated campaign software, in accordance to some embodiments.

FIG. 3 is a table that illustrates an audience data structure, in accordance with some embodiments.

FIG. 4 is a table that illustrates a campaign data structure, in accordance with some embodiments.

FIG. 5 is representation of a campaign media, in accordance with some embodiments.

FIG. 6 is a flowchart of a method of distributing campaign media, in accordance with some embodiments.

FIG. 7 is a flowchart of a method of selecting the at least one target audience for the campaign media from the plurality of audiences based on the campaign data structure and the audience data structures, in accordance to some embodiments.

FIG. 8 is a flowchart of scheduling the one or more electronic transmissions of the campaign media to the at least one user device associated with the at least one target audience based on the campaign data structure and the audience data structures, in accordance to some embodiments.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature’s relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Automated campaign systems and methods of operating the same are disclosed. The automated campaign systems distribute campaign media to the user devices of different audiences. Campaign media include audio, video, push notification, text, and pictures in electronic form that include advertising or promotional messaging. It is known that some campaign media is more likely to be effective on different audiences depending on the characteristics of the audience. Audiences include individual, organizations, corporations, businesses, and the like.

In order to distribute the campaign media to the appropriate audiences, campaign data structures are provided to describe different campaign media. For example, content descriptions, sales information, and other types of data are included in the campaign data structures. Audience data structures are provided to describe different audiences. The automated campaign systems select target audiences for the campaign media, determine time slot for transmitting the campaign media to the selected target audiences, and determine communication channel for transmitting the campaign media to the selected target audiences, based on the campaign data structures and the audience data structures. Furthermore, the automated campaign systems schedule electronic transmissions of the campaign media to the user devices of the target audiences.

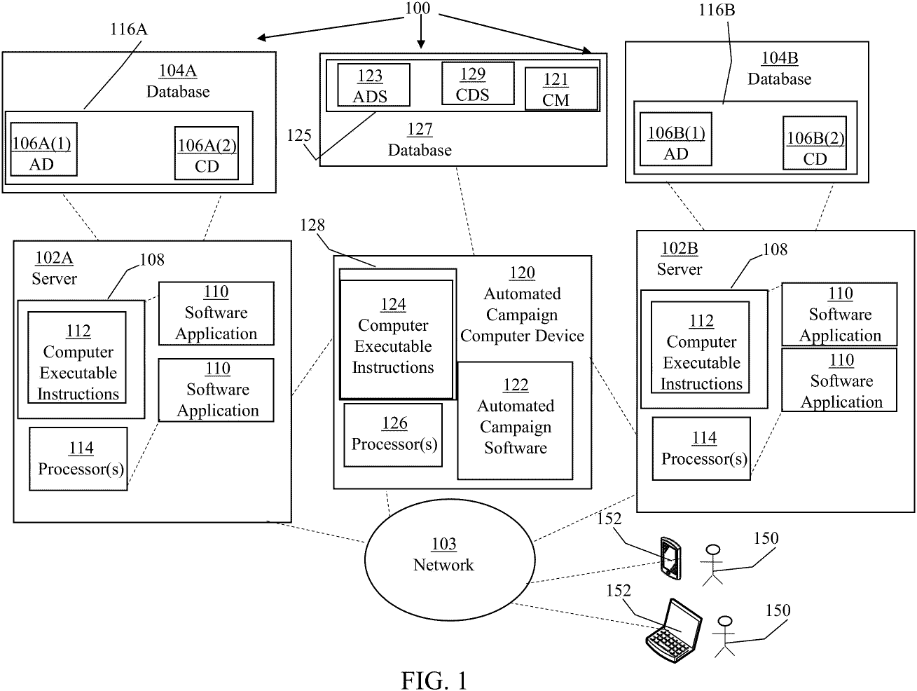

The campaign data structures and the audience data structures provide the information used to link the audiences and the campaign media. In this manner, the automated campaign systems schedule the transmission of the campaign media to the audiences most likely to be receptive to the promotional messages of the campaign media. Furthermore, the automated campaign systems can schedule electronic transmission of the campaign media in the manner most likely to result in a successful campaign. FIG. 1 is a block diagram of an automated campaign system 100, in accordance with some embodiments.

Automated campaign system 100 includes servers 102A, 102B (referred to generically or collectively as server(s) 102) that are operably connected to databases 104A, 104B (referred to generically or collectively as databases 104). Servers 102 are connected to a network 103 and are configured to manage the processing (e.g., writing and storing) of data 106A(1), 106A(2), 106B(1), 106B(2) (referred to generically or collectively as data 106) stored in non-transitory computer readable media 116A, 116B (referred to collectively or generically as non-transitory computer readable media 116). In some embodiments, the network 103 includes a wide area network (WAN) (i.e., the internet), a wireless WAN (WWAN) (i.e., a cellular network), a local area network (LAN), and/or the like.

More specifically, the server 102A is communicatively connected (e.g., through a device interface) to database 104A. In some embodiment, database 104A is included in server 102A. In some embodiment, database 104A and server 102A are included in a cloud server. The database 104A includes non-transitory computer readable media 116A that stores audience data (AD) 106A(1). In some embodiments, the audience data 106A(1) has a particular database format, such as Java Script Object Notation (JSON), American Standard Code for Information Interchange (ASCII), extensible markup language (XML), comma separated values (CSV), or the like. The database 104A is also configured to store campaign data (CD) 106A(2). In some embodiments, campaign data 106A(2) has a particular database format, such as JSON, ASCII, XML, CSV, or the like. In some embodiments, audience data 106A(1) and campaign data 106A(2) have database formats written in the same database language. In other embodiments, audience data 106A(1) and campaign data 106A(2) have database formats that are written in different database languages.

The server 102B is communicatively connected (e.g., through a device interface) to database 104B. In some embodiment, database 104B is included in server 102B. In some embodiment, database 104B and server 102B are included in a cloud server. The database 104B includes non-transitory computer readable media 116B that stores audience data 106B(1). In some embodiments, the audience data 106B(1) has a particular database format, such as JSON, ASCII, XML, CSV, or the like. The database 104B is also configured to store campaign data (CD) 106B(2). In some embodiments, campaign data 106B(2) has a particular database format, such as JSON, ASCII, XML, CSV, or the like. In some embodiments, audience data 106B(1) and campaign data 106B(2) have database formats written in the same database language. In other embodiments, audience data 106B(1) and campaign data 106B(2) have database formats that are written in different database languages.

Audience data 106A(1) and audience data 106B(1) are referred to generically or collectively as audience data 106(1). Campaign data 106A(2) and campaign data 106B(2) are referred to generically or collectively as campaign data 106(2). Audience data 106A(1) and campaign data 106A(2) are referred to generically or collectively as data 106A. Audience data 106B(1) and campaign data 106B(2) are referred to generically or collectively as data 106B. Audience data 106A(1), audience data 106B(1), campaign data 106A(2), and campaign data 106B(2) are referred to generically or collectively as data 106.

It should be noted that JSON, ASCII, XML, and CSV are simply exemplary database languages and are not in any way limiting. In some embodiments, the data 106 are in database formats written in other suitable database languages. In some embodiments, the data 106A and data 106B of each database 104 are in database formats written in the same database language JSON, ASCII, XML, and CSV. In other embodiments, the data 106A and data 106B are in database formats written different database languages JSON, ASCII, XML, and CSV. For example, in some embodiments, some of the data 106A are in JSON and some of the data 106B are in XML.

To manage the writing and storing of data 106 in the databases 104 and to perform other functionality, the servers 102 implement software applications 110. Software applications 110 are provided as computer executable instructions 112 that are executable by one or more processors 114 in each of the servers 102. The computer executable instructions 112 are stored on non-transitory computer readable medium 108 within each of the servers 102. In some embodiments, non-transitory computer-readable media 108, 116 include a random-access memory (RAM), a read-only memory (ROM), an electrically erasable programmable ROM (EEPROM), optical disk storage, magnetic disk storage, other magnetic storage devices, combinations of the aforementioned types of computer-readable mediums, or any other medium that can be used to store computer executable code in the form of instructions or data structures that can be accessed by a computer.

In FIG. 1, the automated campaign system 100 includes more than one of the servers 102 and more than one of the databases 104. Also, in FIG. 1, each of the servers 102 is configured to manage one of the databases 104. In other embodiments, the automated campaign system 100 includes a single server 102 and a single database 104. In still other embodiments, each of the servers 102 manages multiple database 104. In still other embodiments, multiple servers 102 are configured to manage the same subset of one or more databases 104. These and other configurations for the automated campaign system 100 are within the scope of this disclosure.

The audience data 106(1) includes information or data fields that describe different audiences. In some embodiments, an audience is a person, groups of people, organization, business, and/or the like. In some embodiments, audience data 106(1) includes data fields describing the audience such as gender, age group, location, shopping history, products, bookmarks, events, cart lists, lists of products of interest, types of campaigns that have been transmitted to the audience member, emails, webpages, telephone numbers, idol, type of user equipment which the potential audience is using, timing when the potential audience has access to the user equipment, the communications channel(s) available to the audience, which communication channels are more accessible to the audience, and any other suitable information.

Campaign data 106(2) includes information or data fields that describe different campaign media 121. The database 127 stores multiple campaign media 121. Campaign media 121 include any type of electronic media or sets of electronic media that include messages (e.g., videos, emails, texts) promoting ideas, actions, products and/or services. Campaign media 121 are also stored by the non-transitory computer readable medium 125 of the database 127. Each campaign media 121 communicates visual, audible, and/or written message(s) regarding the promotion of ideas, products, and/or services. In some embodiments, campaign media 121 include electronic advertisements. In some embodiments, campaign media 121 communicate a theme related to a marketing communication. The campaign media 121 are stored on the database 127 on non-transitory computer readable medium 125.

Campaign data 106(2) include data (in some cases metadata) related to the campaign media 121. For example, in some embodiments, the campaign data 106(2) includes metadata describing the campaign media 121. In some embodiments, the campaign data 106(2) includes statistical data describing statistic regarding the effect of the campaign on different audiences. In some embodiments, the campaign data 106(2) includes data fields describing a priority of a campaign, success rate of the of campaign in the past, popularity of the campaign, campaign design, keywords related to the campaign, most successful communication channels for distributing the campaign, communication channels that are available for distributing the campaign media 121, content of the campaign media 121, timing and occasions associated with the campaign (e.g., national holidays, Christmas Eve, Valentine Day, final match of a specific sport, etc.), and some other suitable data and information. Campaign data 106(2) is gathered where different instances of the campaign media 121 have been distributed, and/or where data has been extracted from the distribution of the campaign media 121 or the campaign media 121 itself.

The automated campaign system 100 thus includes an automated campaign device 120. The automated campaign device 120 is a computer device that implements the automated campaign software 122 as computer executable instructions 124 executed on one or more processors 126. The computer executable instructions 124 are stored on a non-transitory computer readable medium 128. In some embodiments, non-transitory computer-readable media 128 include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer device.

Automated campaign software 122 is configured to standardize the data 106 into a standardized database format. More specifically, automated campaign device 120 is configured to obtain the data 106 from the databases 104 (e.g., via server 102), define a standardized database format, and convert the data structures 106 into data structures 123 and data structures 129, wherein the data structures 123 and data structures 129 are each in the standardized database format. The data structures 123 and data structures 129 are stored on a non-transitory computer readable media 125 in a database 127. In some embodiment, the data structures 123 and the data structures 129 are stored on one or more of the non-transitory computer-readable media 108, 116, 125, and 128. In some embodiments, the data structures 123 and the data structures 129 are configured as database tables written in the same database language that each include the data fields from the data 106.

More specifically, the automated campaign software 122 is configured to covert the audience data 106(1) into audience data structures (ADS) 123 that are in a standardized audience database format. In some embodiments, each of the audience data structures 123 are audience database tables 123 that have a standardized audience database format. The automated campaign software 122 is configured to convert the customer data 106(2) into campaign data structures (CDS) 129 that are in a standardized campaign database format. In some embodiments, each of the campaign data structures 129 is a campaign database table that has a standardized campaign database format. In some embodiments, the automated campaign software 122 is configured to include scripts that convert the data 106 into the audience data structures 123 and the campaign data structures 129 regardless of the database language (e.g., JSON, ASCII, XML, and CSV) of the database format.

The automated campaign software 122 of the automated campaign device 120 is configured to obtain the campaign data structures 123 and the audience data structures 129 from the non-transitory computer readable medium 125 of the database 127. For each of the campaign media 121, the automated campaign software 122 of the automated campaign device 120 is configured to select at least one target audience for the campaign media 121 from the plurality of audiences 150 based on the campaign data structure 129 associated with the particular campaign media 121 and the audience data structures 123 that describe each of the audiences 150, to determine at least one time slot to transmit the campaign media 121 to the selected target audience, and to determine at least one communication channel to transmit the campaign media 121 to the selected target audience. Subsequently, the automated campaign software 122 is configured to schedule one or more electronic transmissions of the particular campaign media 121 to at least one user device 152 associated with at least one selected target audience 150. Examples of user devices 152 include a cellular phone, a smart phone, a session initiation protocol (SIP) phone, a laptop, a smart watch, a personal digital assistant (PDA), a satellite radio, a global positioning system, a multimedia device, a video device, a digital audio player (e.g., MP3 player), a camera, a game console, a tablet, a smart device, and a wearable communication device.

In some embodiment, the campaign media 121 is transmitted by the automated campaign software 122 to the selected user devices 152 through the network 103. In some embodiments, the automated campaign software 122 is configured to select the communication channel or communication channels for transmitting the campaign media 121. For example, in some embodiments, the automated campaign software 122 is configured to select whether the campaign media 121 is transmitted via email, push notification, text message, video, or audio to the selected user device 152. In some embodiments, the automated campaign software 122 is configured to select the communication channel based on statistical data derived from the audience data structures 123 and the campaign data structures 129.

In some embodiments, the audience data structures 123 include data fields that identify how many times and when the audience 120 described by the audience data structure 123 has received a particular campaign media 121. In this manner, selecting the target audience 150 for the particular campaign media 121 is done in a manner that is most effective and least bothersome to the selected audience 150. For example, in some embodiments, the automated campaign software 122 determines one or more audiences 150 from the plurality of audiences 150 that have already received the particular campaign media 121 more than a threshold number of times within a specified time period based on the audience data structures 123. The automated campaign software 122 then flags the audience data structure(s) 123 associated with the audience(s) 150 as being non-selectable so that the non-selectable audiences are removed from the general pool of audiences 150 that are selectable as selectable audiences 150. The target audience 150 for the particular campaign media 121 is then selected from the plurality of selectable audiences 150. In this manner, audiences 150 that have already received the campaign media 121 a threshold number of times within a specified time period (within the last week, within the last month, etc.) do not receive the campaign media 121 again. In some embodiment, the target audience is selected based on other audience information included in the audience data structures 123. For instance, the automated campaign software 122 select the target audience based on the audience type, audience age group, audience location, audience history, audience birthday, and any other suitable audience information.

In some embodiments, the automated campaign software 122 is configured to schedule the transmission time of the campaign media 121 to the target audience 150. The automated campaign software 122 is configured to obtain audience availability data including time availability data for the target audience 150 from the audience data structure 123 related to the target audience 150. In some embodiments, the time availability data identifies when the audience 150 is online and via what communication channels. In some embodiments, the campaign data structure 129 for the particular campaign media 121 also includes timing data regarding when transmitting the particular campaign media 121 is most effective. The automated campaign software 122 is configured to select one or more time slots for one or more electronic transmissions of the campaign media 121 based on the time availability data in the audience data structure 123 and the campaign data structure 129. In some embodiment, the automated campaign software 122 is configured to schedule the transmission time of the campaign media 121 to the target audience 150 according to the priority and/or urgency of the campaign. Furthermore, the automated campaign software 122 is configured to select one or more communication channels for transmission of the campaign media 121 based on the campaign data structure 129 and the audience data structure 123 for the target audience 150. In this manner, the transmission of the particular campaign media 121 to the user device(s) 152 of the target audience 150 is automated by the automated campaign software 122.

The automated campaign software 122 is configured to select target audiences 150 and schedule transmission of each of the campaign media 121. Accordingly, the automated campaign software 122 is configured to repeat the selection and scheduling procedures discussed above various times for each of the campaign media 121 in some embodiments. In some embodiments, the automated campaign software 122 is configured to select target audiences 150 and schedule transmission simultaneously for all of the campaign media 121 in the database 127. In some embodiments, the campaign media 121 are found in more than one database, like the database 127.

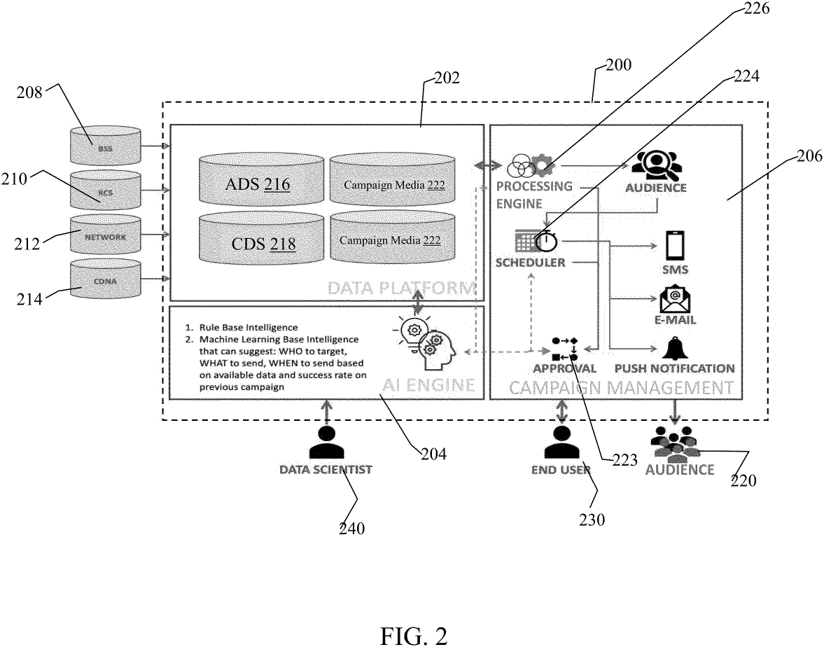

FIG. 2 is a block diagram illustrating automated campaign software 200, in accordance to some embodiments.

The automated campaign software 200 corresponds with the automated campaign software 122 in FIG. 1. The automated campaign software 200 includes a data platform module 202, an AI engine 204, and a campaign management module 206.

The data platform module 202 is configured to receive data structures 208, 210, 212, 214, from one or more data sources. The data sources include different network systems, different vendor computer devices, different user computer devices, databases in one or more network locations, the cloud, and/or other software applications (e.g., through an application programming interface (API)).

In some embodiment, data structures 208 are received from a business support system (BSS). The data structures 208 are provided in a particular database format written in a particular database language. Data structures 210 are received from rich communication services (RCS). The data structures 210 are provided in a particular database format written in a particular database language. Data structures 212 are received from network systems. The data structures 212 are provided in a particular database format written in a particular database language. Data structures 214 are received from customer’s data management platform, such as customer DNA (CDNA) platform. The data structures 214 are provided in a particular database format written in a particular database language.

In some embodiments, data structures 208, 210, 212, 214 include audience data and campaign data in database formats written in different database languages. The data platform module 202 is configured to convert the data structures 208, 210, 212, 214 into audience structures 216 that are in standardized audience database formats and campaign data structures 218 that are in standardized campaign database formats. In some embodiments, the standardized database formats are written in the same database language. Thus, the data platform module 202 is configured to receive the data structures 208, 210, 212, 214, and generate data structures 216, 218 in standardized database formats.

The campaign management module 206 includes a scheduler 224 and a processing engine 226. The processing engine 226 is configured to obtain the audience data structure 216 and customer data structure 218 from the data platform. Subsequently, based on the audience data structure 216 and customer data structure 218, the processing engine 226 is configured to select at least one target audience among audience 220, to determine at least one time slot for sending the campaign media 222 to the selected target audience, and to determine at least one communication channel for sending the campaign media 222 to the selected target audience. In some embodiment, the audiences 220 with the audience data structures 216 that are associated with campaign data structures 218 are selected as target audiences for the campaign media 222 described by the associated campaign data structures 218. In some embodiments, the processing engine 226 associates the campaign data structures 218 with the audience data structures 216 by implementing k-clustering. K-clustering uses vector quantization, to partition the audience data structures 216 into k clusters in which each campaign data structures 218 belongs to the cluster with the nearest mean (cluster centers or cluster centroid). This results in a partitioning of the data space into Voronoi cells. The processing engine 226 is communicatively coupled to the scheduler 224 and an end user 230, and is configured to transmit the determined information to the scheduler 224 and the end user 230.

The scheduler 224 is configured to schedule the transmission of campaign media 222 to the selected target audience(s) based on the determined time(s) and communication channel(s). The scheduled transmission is sent to the end user 230 for review and approval.

The end user 230 (such as a campaign manager, an event operator, and any suitable personnel that in charge of promoting the campaign) can review the information determined by the processing engine 226 and the transmission scheduled by scheduler 224, make any revision or adjustment thereon if required, and approve/reject the information determined by the processing engine 226 and the transmission scheduled by scheduler 224. The end user input regarding a selection is sent to the processing engine 226, scheduler 224, and AI engine 204. In some embodiment, the processing engine 226, based on the user input, will re-select the target audience(s), re-determine the time(s) for sending the campaign media 222, and/or re-determine the communication channel(s). In some embodiment, the scheduler 224, based on the user input related to a selection, will reschedule the transmission of campaign media 222.

In some embodiment, instead of manually reviewing, revising, approving, and/or rejecting the determined information and/or the scheduled transmission, the end user 230 can set up an approval procedure 223 based on a per-set condition(s), such that the campaign management module 206 can automatically revise/approve/reject (e.g., with the processing engine 226 or another processing engine 226 dedicated for the approval procedures) the information determined by the processing engine 226 and the transmission scheduled by scheduler 224. For instance, if the determined information and/or the scheduled transmission fulfills one or more of the pre-set condition(s), the determined information and/or the scheduled transmission will be automatically revised in a manner pre-set by the end user, be automatically approved, and/or be automatically rejected. In some embodiment, if the processing engine 226 and/or scheduler 224 does not receive any user input from the end user 230 within a period of time, the processing engine 226 and/or scheduler 224 will assume that the determined information and scheduled transmission is approved. Subsequently, the scheduler 224 is configured to carry out the transmission of campaign media 222 to the selected target audience(s) 220 on the scheduled time(s) via the determined communication channel(s). For instance, the scheduler 224 is configured to transmit the campaign media 222 to the user devices of the target audiences 220 during the selected time slots and via the selected communication channels.

In some embodiments, the communication channels include text message, email, push notifications, and any other suitable communication channels. In some embodiment, if the processing engine 226 and/or scheduler 224 does not receive any user input from the end user 230 within a period of time, the determined information and/or the scheduled transmission will be expired, and no transmission of campaign media 222 will be carried out. In some embodiments, the AI engine 204 is communicatively coupled to the data platform module 202, the processing engine 226, the scheduler 224, and/or the processing engine 226 dedicated for approval procedure 223 (if any). The AI engine 204 is configured to assist the operation of the data platform module 202, the processing engine 226, the scheduler 224, and/or the processing engine dedicated for approval procedure 223. Specifically, the AI engine 204 is configured to obtain the information determined by processing engine 226, the transmission scheduled by scheduler 224, the user input regarding a selection made by the end user 230 via an approval procedure 223, and/or the data structures 216 and 218, and to process to obtained information to train an AI model of the AI engine 204.

For instance, the AI engine 204 is configured to determine the accuracy of the determined information and/or the scheduled transmission, based on the end user’s input (e.g., revision, approval, rejection). For example, if it is determined that the end user 230 simply agree with the determined information and/or the scheduled transmission, the AI engine 203 is configured to recognize that the information determined by the processing engine 226 and/or the transmission scheduled by the scheduler 224 is accurate, and is configured to provide the determined information and scheduled transmission to the processing engine 226 and/or scheduler 224, respectively, in the future when the processing engine 226 and/or the scheduler 224 is processing the data structures 216, 218 for the similar campaign media 222. The AI model is updated by the AI engine 204 based on the end user’s input (e.g., revision, approval, rejection) with respect to the approval procedure 223 so that in the future when the processing engine 226 and/or the scheduler 224 is processing the data structures 216, 218 for the similar campaign media 222 similar associations are provided to the processing engine 226.

If the end user 230 wants to revise the suggestion provided by the processing engine 226, the electronic transmissions of the campaign media 222 are executed by the scheduler 224 based on the user input from the end user 230 indicating the revision of the end user 230. The AI engine 204 is configured to analyze the resulting configuration for the electronic transmissions of the campaign media 222 and use the resulting configuration to provide one or more indicative parameters that train the AI model to process the next recommendation by the processing engine 226.

If the user input from the end user 230 indicates that end user 230 has rejected the suggested configuration, the electronic transmission of the campaign media is not executed the scheduler 224. In some embodiments, the processing engine 226 is configured to provide visual indicators requesting that the end user 230 provide a user input indicating the reason why the suggested configuration was rejected. The AI engine 204 is configured to use this user input as one or more parameters that train the AI model to process next recommendation provided to the processing engine 226.

In some embodiment, the AI engine 204 is configured to compare the determined information and/or the scheduled transmission to a previous success rate of campaign media 222, or to compare the determined information and/or the scheduled transmission to any other suitable information obtained from data platform module 202 and campaign management module 206, to thereby determine the accuracy of the performance of processing engine 226 and/or scheduler 224 and to train the AI model based thereon. In some embodiment, the AI engine 204 uses rule base intelligence and machine learning base intelligence to train the AI model, and to provide, based on the trained AI model, suggestions to the processing engine 226 (e.g., suggestions on who can be selected as target audience, what kind of campaign content is suitable for the target audience, when to send the campaign, etc.), to the scheduler 224 (e.g., which kind of transmission scheduling is preferable by the end user 230, etc.), and/or to the end user 230 (e.g., what is the success rate on previous campaign with similar combination of target audience, transmission time, and communication channel, etc.) In some embodiment, the AI model can be further trained or refined by a data scientist 240, so as to further increase the accuracy of the suggestion provided by the AI engine 204.

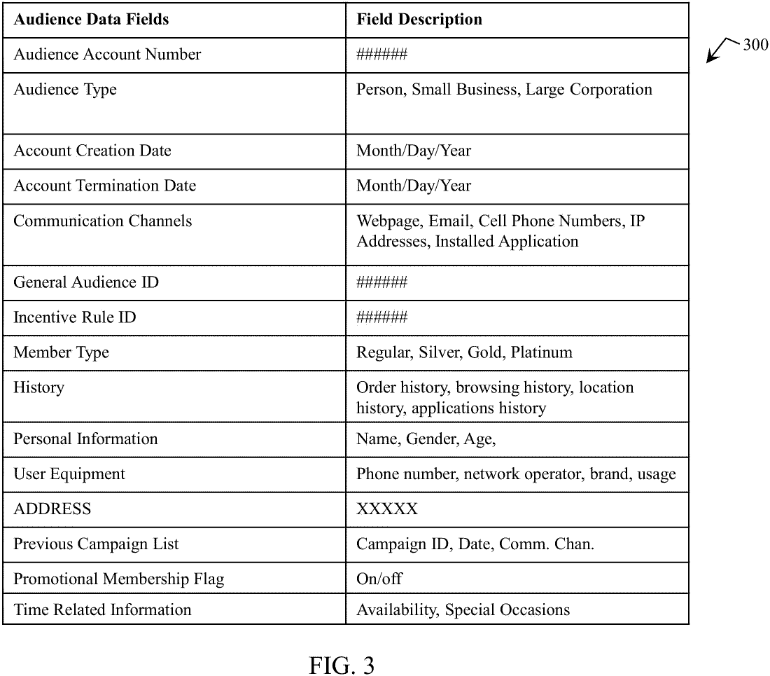

FIG. 3 is a table that illustrates an audience data structure 300, in accordance with some embodiments.

The audience data structure 300 corresponds with the audience data structures 123 in FIG. 1 and audience data structures 216 in FIG. 2, in accordance with some embodiments. The audience data structure 300 is a database table in a standardized audience database format. The audience data structure 300 includes data related to an audience.

The audience data structure 300 includes an audience data field named “Audience Account Number.” This audience data field includes a audience account number to identify a user profile for the audience.

The audience data structure 300 includes an audience data field named “Audience Type.” This audience data field describes the type of audience, such as whether the audience is a person, small business, or large corporation. In some embodiments, audience types such as a business organization are sometimes linked to other audience data structures related to the people within the organization. In some embodiments, communication channels for business organizations include official communication channels for the organization and/or the communication channels of at least some of the individuals working at the organization.

The audience data structure 300 includes an audience data field named “Account Creation Date.” This audience data field identifies the date that the account was created for the audience.

The audience data structure 300 includes an audience data field named “Account Termination Date.” This audience data field identifies the date that an account was terminated for the audience, if any. In some embodiments, the transmission of campaign media to the user devices of audiences with active accounts and inactive accounts are treated in different manners as a result of permissions that have been granted by audience members for active accounts.

The audience data structure 300 includes an audience data field named “Communication Channels.” This audience data field identifies emails, webpages, cell phone numbers, IP addresses, application installed on user’s equipment, and any other suitable channels that are available to communicate with the audience. The processing engine 226 and/or scheduler 224 described above in FIG. 2 is configured to take these into account during their respective operation.

The audience data structure 300 includes an audience data field named “General Audience ID.” This audience data field includes a audience ID that is used to identify the audience across a plurality of platforms, such as across different bank accounts, credit card accounts, promotional accounts, e-commerce platform accounts, mobile subscription accounts, insurance accounts, e-payment accounts, social network accounts, and any suitable account types.

The audience data structure 300 includes an audience data field named “Incentive Rule ID.” This audience data field includes an identification number that identifies rules for incentivizing the audience described by the audience data structure 300. In some embodiments, the audience is provided with certain rules of discount in order to incentivize the audience to participate in a campaign. In some embodiments, this includes loyalty programs, discount programs, and/or the like. The “Incentive Rule ID” includes a number and/or word that identifies the incentive rules. The incentive rules identify whether the audience is allowed to have certain discounts related to a campaign. In some embodiments, the audience is a target audience depending on whether the audience is subject to certain incentive rules.

The audience data structure 300 includes an audience data field named “Member Type.” This audience data field separates audience member into different classes such as, regular, silver, gold, and platinum in order to identify their loyalty to certain businesses or products. In some embodiment, the member type affects the incentives received by the audience, in addition to the incentive rules (e.g., a regular member only receives the incentive which is determined based on the incentive rules, a silver member receives 110% of the incentive determined based on the incentive rules, a gold member receives 130% of the incentive determined based on the incentive rules, a platinum member receives 150% of the incentive determined based on the incentive rules, etc.) In some embodiments, whether the audience is subject to a campaign depends on their member type or class status.

The audience data structure 300 includes an audience data field named “History.” This audience data field identifies historical data of the audience, such as orders made by the audience (includes an order ID, the product type, the type of payment made, and the price of each of the orders made by the audience, etc.), the search and browsing history (e.g., on e-commerce platform, on social media platform, on certain campaign media, etc.), the location history of the audience, applications installation and/or running history, and any other suitable type of historical information of the audience. The “History” field helps to identify whether the subject of the campaign is of interest to the audience.

The audience data structure 300 includes an audience data field named “Personal Information.” This audience data field identifies personal information of the audience such as their name, gender, age. The personal information” field is used to determine the demographics of the audience, which helps to identify whether the campaign is of interest to the audience.

The audience data structure 300 includes an audience data field named “User Equipment.” This audience data field includes information such as one or more telephone numbers associated with the audience, the brand or manufacturer of the user equipment using by the audience, the network operator subscribed by the audience, the usage of user equipment, and any other suitable associated information. An area code of the phone number in “User Equipment” field helps identify a location of the audience. The usage of user equipment in the “User Equipment” field helps identify which user equipment is most frequently used by the audience, if the audience has multiple user equipment. The “User Equipment” field also helps identify telephonic or cellular communication channels for the audience.

The audience data structure 300 includes an audience data field named “address.” This audience data field identifies a mailing address of the audience. The mailing address is used to determine whether the campaign is of interest to the audience. For example, some campaigns have geographic limitations or are only related to one or more store locations. The mailing address is thus used to determine if the campaign is of interest to the audience.

The audience data structure 300 includes an audience data field named “Previous Campaign List.” This audience data field identifies a campaign ID, dates, and/or communication channels used to communicate different campaign media to the user. In this manner, the “Previous Campaign List” field is used to prevent the audience from being oversaturated with certain campaign media.

The audience data structure 300 includes an audience data field named “Promotional Membership Flag.” This audience data field is a flag that is on or off that identifies whether the audience is subject to certain promotions.

The audience data structure 300 includes an audience data field named “Time Related Information.” This audience data field identifies times and dates when the audience is available via different communication channels. “Time Related Information” also identifies special occasions such as birthdays or anniversaries. The “Time Related Information” is used by the scheduler to schedule transmission of the campaign media.

The audience data fields of the audience data structure 300 are used by the processing engine 226 to match the audiences with the campaign media. The fields of audience data structure 300 describe different audiences and thereby allow for the processing engine 200 to match the appropriate audiences with campaign media.

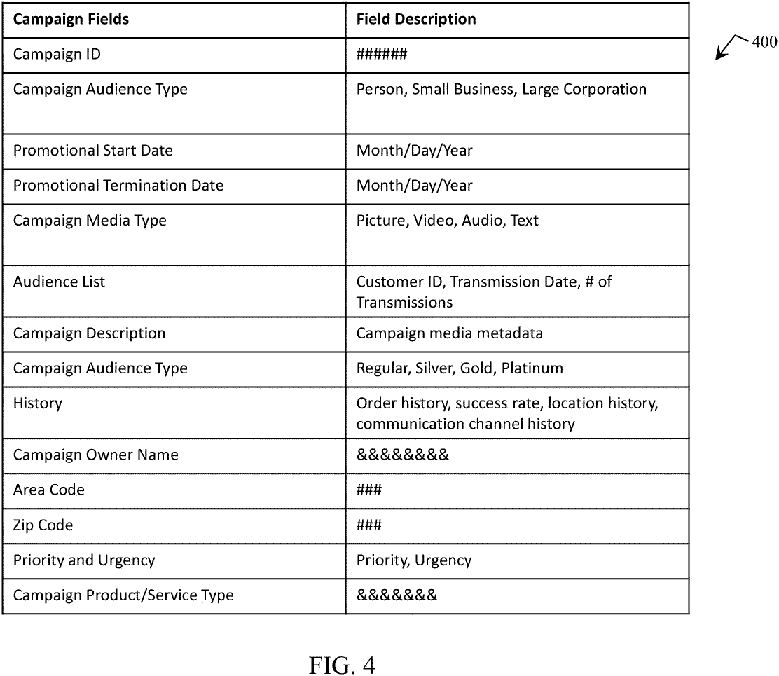

FIG. 4 is a table that illustrates a campaign data structure 400, in accordance with some embodiments.

The campaign data structure 400 corresponds with the campaign data structures 129 in FIG. 1 and campaign data structures 218 in FIG. 2, in accordance with some embodiments. The campaign data structure 400 is a database table in a standardized campaign database format. The campaign data structure 400 includes data related to campaign media.

The campaign data structure 400 includes a campaign data field named “Campaign ID.” This campaign data field includes a campaign identification number that identifies the campaign media.

The campaign data structure 400 includes a campaign data field named “CampaignAudience Type.” This campaign data field that identifies the type of entity that the campaign media is such as whether the campaign media is for a person, a small business and/or a large corporation.

The campaign data structure 400 includes a campaign data field named “Promotional Start Date.” This campaign data field identifies the date where a campaign with the campaign media begins.

The campaign data structure 400 includes a campaign data field named “Promotional Termination Date.” This campaign data field identifies when the campaign with the campaign media ends.

The campaign data structure 400 includes a campaign data field named “Campaign Media Type.” This campaign data field identifies the type of campaign media such as whether the campaign media is a picture, video, audio, and/or text.

The campaign data structure 400 includes a campaign data field named “Audience List.” This campaign data field identifies to the audience members that the campaign media has already been sent to, the transmission dates for sending the campaign media to the audience members, and the number of times that the campaign media has been sent to the audience member.

The campaign data structure 400 includes a campaign data field named “Campaign Description.” This campaign data field includes information that describes the campaign media. In some embodiments, the “campaign description field” includes campaign media metadata describing the campaign media.

The campaign data structure 400 includes a campaign data field named “Campaign AudienceType.” This campaign data field identifies what class of customers the campaign media is directed to such as regular, silver, gold, or platinum.

The campaign data structure 400 includes campaign data fields under the name “History.” These campaign data field(s) includes historical information of the campaign, such as order history (e.g., a list of orders that have been made related to a product or service being promoted by the campaign media, order ID, audience ID, product type, payment type, price, etc.), success rate (e.g., the rate in which the audience participated in the same campaign in the past, which type of audience has the highest success rate in this campaign in the past, which location has the highest success rate, which communication channel has the highest success rate, etc.), location history (e.g., which location has this campaign promoted in the past, etc.), and any other suitable historical information. In this manner, the processing engine 226 is configured to determine whether the campaign media should be transmitted to certain audiences. For instance, if the audience has already participated in the campaign (e.g., has already bought a product or service) in the past, the processing engine 226 will determine to not send the campaign media to the audience in some circumstances. In other circumstances, the processing engine 226 will determine that the campaign media should be send to the audience if the audience has already bought a product or service. In some embodiments, this depends on the type of product or service that is the subject of the campaign media. In another example, if the campaign media 222 has been promoted in a certain location for a number of time, the processing engine 226 will determine to not send the campaign media 222 to the audience 220 located in that location. In addition to selecting target audience 220, the information in the campaign data structure 400 is also useful in determining the time slot and communication channel for transmitting the campaign media. For instance, if the campaign media 222 has a highest success rate on time X via communication channel Y, the processing engine 226 will select audience which is available on time X via communication channel Y as the target audience.

The campaign data structure 400 includes a campaign data field named “Campaign Owner Name.” This campaign data field identifies the owner or personnel in charge of the campaign media.

The campaign data structure 400 includes a campaign data field named “Area Code.” This campaign data field identifies one or more area codes associated with the campaign media. Some campaigns are regional so the campaign media is to be distributed only in certain areas.

The campaign data structure 400 includes a campaign data field named “Zip Codes” This campaign data field identifies one or more zip codes associated with the campaign media. Some campaigns are regional so the campaign media is to be distributed only in certain areas.

The campaign data structure 400 includes a campaign data field named “Priority and Urgency.” This campaign data field includes data that identifies the priority and urgency of the campaign. In some embodiment, the processing engine 224 determines the time slot and/or communication channel for sending the campaign media to the target audience, based on the priority and/or urgency of the campaign media. For instance, if the campaign media is having high urgency (e.g., a campaign for giving special offer to compensate audiences who are unsatisfied with a subscribed service, a campaign for upgrading audience member type to compensate audiences who are affected by network system issues, etc.), the processing engine 224 will determine that the campaign media has to be sent as soon as possible via all possible communication channels. In another example, if the campaign media is having high priority (e.g., a campaign for promoting a new service, a campaign for limited time sales, etc), the processing engine 224 will determine that the campaign media has to be sent as many time as possible via all possible communication channels..

The campaign data structure 400 includes a campaign data field named “Campaign Product/Service Type.” This campaign data field identifies the product and/or services that relate to the subject matter of the “Campaign Product/Service Type.”

Thefields in the campaign data structure 400 are used by the processing engine 226 to determine matches between the campaign media and the audiences, to thereby select the target audience, determine the time slot for sending the campaign media to the target audience, and determine the communication channel for sending the campaign media to the target audience.

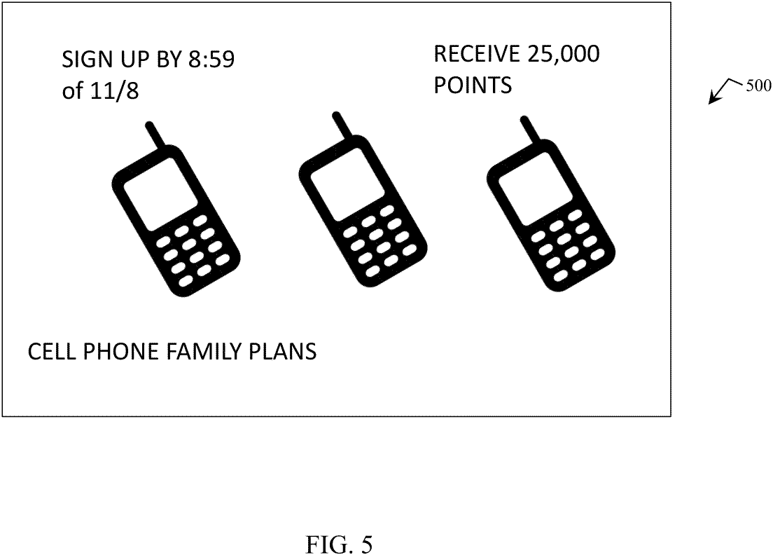

FIG. 5 is representation of a campaign media 500, in accordance with some embodiments.

The campaign media 500 is an example of the campaign media 121 in FIG. 1 and the campaign media 222 in FIG. 2. In this example, the campaign media 500 is a combination of texts and figures. Other examples of campaign media include audio, video, and/or text.

As shown in FIG. 5, the campaign media 500 includes promotional messaging related to a mobile network operator family subscription plan (e.g., if members in a family subscribe to the mobile network operator by 8:59 of 11/8, a maximum of 25000 points which can be used in other platforms for purchasing, paying bills, etc. will be rewarded, etc.). Information related to the promotion is visually displayed in text. Conditions, number of reward points, times, and dates of the promotion are included in the campaign media. This is merely an example of campaign media, and other campaign medias (e.g., sales promotion, events promotion, product recommendation, subscription plan recommendation, etc.)

The processing engine 226 uses a campaign data structure (like the campaign data structure 400 shown in FIG. 4) and audience data structures (like the audience data structure 300 shown in FIG. 3) to find a target audience for the campaign media 500. The scheduler 224 shown in FIG. 2 is configured to schedule electronic transmission of the campaign media 500 to the user devices of the selected target audience via the selected communication channel.

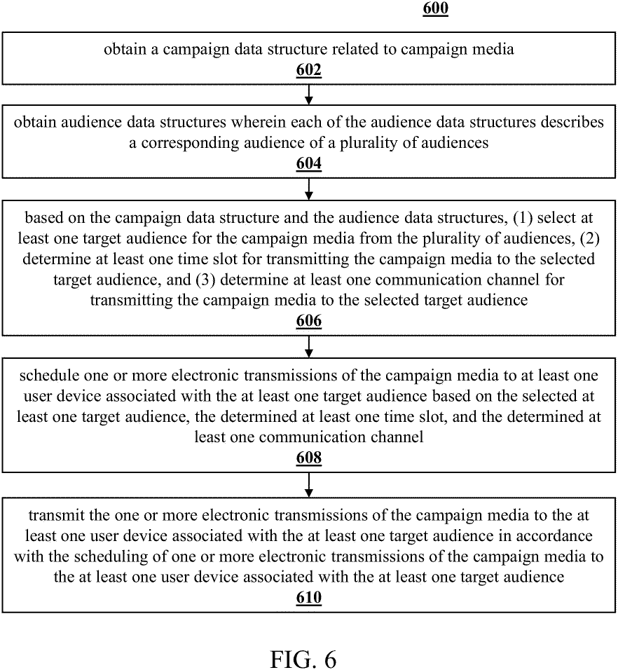

FIG. 6 is a flowchart 600 of a method of distributing campaign media, in accordance with some embodiments.

Flowchart 600 is implemented by the automated campaign computer device 120 in FIG. 1 and the automated campaign software 200 shown in FIG. 2. Flowchart 600 includes blocks 602-610. Flow begins at block 602.

At block 602, a campaign data structure related to campaign media is obtained. The campaign data structure includes data describing the campaign media. Examples of the campaign data structure include the campaign data structures 129 in FIG. 1, the campaign data structures 218 in FIG. 2, and the campaign data structure 400 in FIG. 4. Examples of the campaign media include the campaign media 121 in FIG. 1, the campaign media 222 in FIG. 2, and the campaign media 500 in FIG. 5. Flow then proceeds to block 604.

At block 604, audience data structures are obtained wherein each of the audience data structures describes a corresponding audience of a plurality of audiences. The audience data structures include data related to an audience. Examples of audience data structures include audience data structures 123 in FIG. 1, audience data structures 216 in FIG. 2, and audience data structure 300 in FIG. 3. Examples of audiences include audiences 150 in FIG. 1 and audiences 220 in FIG. 2. Flow then proceeds to block 606.

At block 606, based on the campaign data structure and the audience data structures, at least one target audience for the campaign media from the plurality of audiences is selected, at least one time slot for transmitting the campaign media to the selected target audience is determined, and at least one communication channel for transmitting the campaign media to the selected target audience is determined. In some embodiments, a processing engine is implemented that is configured to associate the campaign data structure with the audience data structures so as to select the at least one target audience for the campaign media from the plurality of audiences, to determine the at least one time slot for transmitting the campaign media, and to determine the at least one communication channel. Examples of the processing engine include the processing engine 226 in FIG. 2. In some embodiments, the processing engine implements k-clustering to associate the campaign data structure with the audience data structures.

The campaign data structures and the audience data structures allow for the selection of target audiences based on the audience profile information and the information regarding campaign media. For example, for a campaign with campaign media having promotional messaging that is focused on a festival in Japan, only audiences in Japan are selected as target audience, in some embodiments. For a campaign with campaign media that includes promotional messaging associated with a product (e.g., screen protector for mobile phone X), audiences which are using mobile phone X, have purchased mobile phone X, and/or has browsing history of mobile phone X, are selected as target audiences, in accordance with some embodiments. For a campaign with campaign media that is related to a cosmetic product, female audiences, audiences who are working in the related field, and/or any audience who shows interests in cosmetic product (e.g., in browsing history, etc.) will be selected as a target audience, in accordance with some embodiments. For a campaign with campaign media related to a special offer for all loyal members, only audiences with a specific member status (e.g., “Gold”, “Platinum”, and the like) are selected, in accordance with some embodiments.

In addition, the campaign data structures and the audience data structures allow for the selection of the at least one time slot for transmitting the campaign media, based on the audience profile information and the information regarding campaign media. For instance, for urgent and/or high priority campaigns, the campaign media associated with the campaign is sent as soon as possible via all communication channels accessible by the target audience, in accordance with some embodiments.

For campaign media that are associated with specific times, the campaign is sent regardless of the user’s availability (e.g., star gazing campaign will be sent on evening, etc.), in accordance with some embodiments.

Furthermore, the campaign data structures and the audience data structures allow for the selection of the at least one communication channel for transmitting the campaign media, based on the audience profile information and the information regarding campaign media. For instance, if the target audience is mainly using their computer in the morning and mainly using mobile phone in the evening, the campaign media is sent to the computer via email or browser notification in the morning and to the mobile phone via sms in the evening, in accordance with some embodiments. Flow then proceeds to block 608.

At block 608, one or more electronic transmissions of the campaign media are scheduled to at least one user device associated with the at least one target audience based on the selected at least one target audience, the determined at least one time slot for transmitting the campaign media, and the determined at least one communication channel. Examples of the user devices include user devices 152 in FIG. 1. In some embodiment, the scheduling is done by a scheduler such as the scheduler 224 in FIG. 2. Flow then proceeds to block 610.

At block 610, the one or more electronic transmissions of the campaign media are transmitted to the at least one user device associated with the at least one target audience in accordance with the scheduling of one or more electronic transmissions of the campaign media to the at least one user device associated with the at least one target audience. In some embodiments, the electronic transmissions of the campaign media are sent through a network, such as the network 103 in FIG. 1.

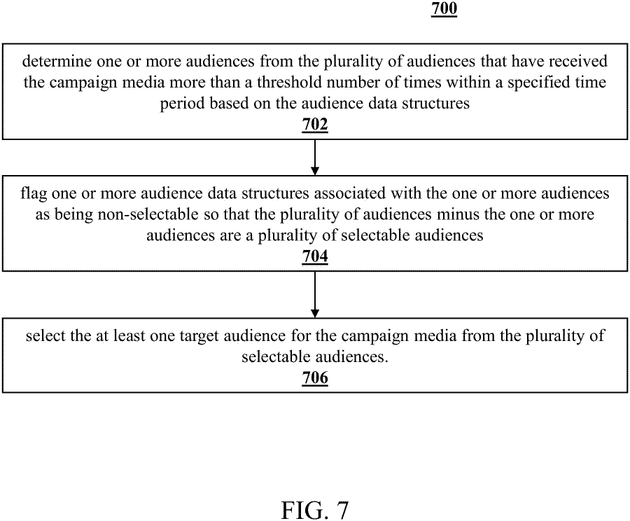

FIG. 7 is a flowchart 700 of a method of selecting the at least one target audience for the campaign media from the plurality of audiences based on the campaign data structure and the audience data structures, in accordance to some embodiments.

Flowchart 700 corresponds to a portion of block 606 in FIG. 6, in accordance to some embodiments. More specifically, flowchart 700 relates a specific implementation of portions of block 606 where the pool of audiences that is used to select a target audience is reduced when audience members have already viewed by the campaign media a threshold number of times. Flowchart 700 however is specifically to this implementation and is not intended to limit the scope of block 606. Flowchart 700 includes blocks 702-706. Flow beings at block 702.

At block 702, one or more audiences from the plurality of audiences that have received the campaign media more than a threshold number of times within a specified time period is determined based on the audience data structures. Flow then proceeds to block 704

At block 704, one or more audience data structures associated with the one or more audiences is flagged as being non-selectable so that the plurality of audiences excluding the one or more audiences are a plurality of selectable audiences. The pool of available audiences is thus reduced to remove the audiences that have already received the campaign media a threshold number of times within a specified period. The threshold number is an integer greater than 1. In some embodiment, the threshold number is selected so as to prevent an audience member from being saturated with the same campaign media. Flow then proceeds to block 706.

At block 706, the at least one target audience is selected for the campaign media from the plurality of selectable audiences.

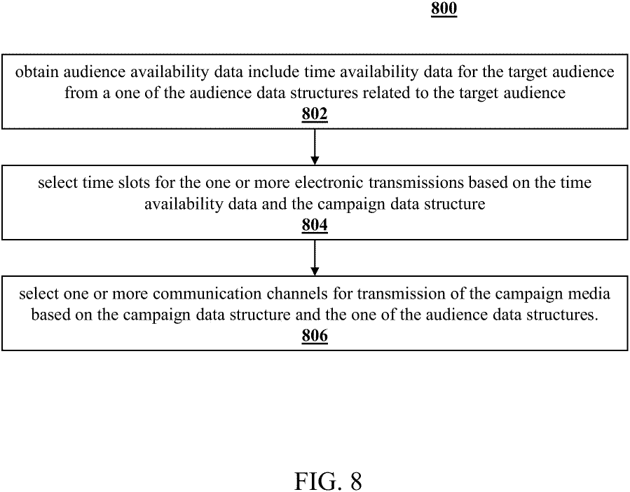

FIG. 8 is a flowchart 800 of determining time slots and a communication channel for transmitting the media campaign, in accordance to some embodiments.

Flowchart 800 corresponds to portions of block 606 in FIG. 6, in accordance with some embodiments. More specifically, flowchart 800 relates to a specific implementation of portions of block 606 when electronic transmissions of the campaign media are scheduled based on audience availability data. Flowchart 800 however is related specifically to this implementation and is not intended to limit the scope of block 606. Flowchart 800 includes blocks 802-806. Flow begins at block 802.

At block 802, audience availability data is obtained that includes time availability data for the target audience from a one of the audience data structures related to the target audience. Examples of time availability data include the “Time Related Information” of the audience data structure 300 in FIG. .3. Flow then proceeds to block 804.

At block 804, time slots are selected for the one or more electronic transmissions based on the time availability data and the campaign data structure. Time slots match the portions of time that the time availability data indicates the audience is online or is otherwise likely to perceive the campaign media. Flow then proceeds to block 806.

At block 808, one or more communication channels are selected for transmission of the campaign media based on the campaign data structure and the one of the audience data structures. In some embodiments, the communications channels include email, text, push notification, phone call, video transmission, audio transmission, and/or the like.

In some embodiment, the end user can opt to overwrite the information determined by the processing engine, the transmission scheduled by the scheduler, the suggestions provided by the AI engine, and/or the data structure provided by the data platform. For instance, the end user can cancel a scheduled transmission, include a specific audience as the target audience, revise the information included in the audience data structure and/or campaign data structure, add new rule to the AI engine, and the like.

In some embodiments, a method, includes: obtaining a campaign data structure related to campaign media; obtaining audience data structures, wherein each of the audience data structures describes a corresponding audience of a plurality of audiences; based on the campaign data structure and the audience data structures and using a computer device, (1) selecting at least one target audience for the campaign media from the plurality of audiences, (2) determining at least one time slot for transmitting the campaign media to the selected target audience, and (3) determining at least one communication channel for transmitting the campaign media to the selected target audience; and scheduling, using the computer device, one or more electronic transmissions of the campaign media to at least one user device associated with the at least one target audience based on the campaign data structure and the audience data structures. In some embodiments, selecting the at least one target audience for the campaign media from the plurality of audiences based on the campaign data structure and the audience data structures includes implementing a processing engine configured to associate the campaign data structure with the audience data structures so as to select the at least one target audience for the campaign media from the plurality of audiences. In some embodiments, implementing the processing engine configured to associate the campaign data structure with the audience data structures includes implementing k-clustering with the processing engine to associate the campaign data structure with the audience data structures. In some embodiments, selecting the at least one target audience for the campaign media from the plurality of audiences based on the campaign data structure and the audience data structures includes: determining one or more audiences from the plurality of audiences that have received the campaign media more than a threshold number of times within a specified time period based on the audience data structures; flagging one or more audience data structures associated with the one or more audiences as being non-selectable so that the plurality of audiences minus the one or more audiences are a plurality of selectable audiences; selecting the at least one target audience for the campaign media from the plurality of selectable audiences. In some embodiments, the method further includes: obtaining a second campaign data structure related to a second campaign media; based on the second campaign data structure and the audience data structures, (1) selecting at least one other target audience for the second campaign media from the plurality of audiences, (2) determining at least one other time slot for transmitting the second campaign media to the selected other target audience, and (3) determining at least one communication channel for transmitting the second campaign media to the selected other target audience. In some embodiments, determining the at least one time slot for transmitting the campaign media to the selected target audience and the at least one communication channel based on the campaign data structure and the audience data structures includes: obtaining audience availability data that includes time availability data for the target audience from a one of the audience data structures related to the target audience; selecting time slots for the one or more electronic transmissions based on the time availability data and the campaign data structure; selecting one or more communication channels for transmission of the campaign media based on the campaign data structure and the one of the audience data structures. In some embodiments, the method of further includes transmitting the one or more electronic transmissions of the campaign media to the at least one user device associated with the at least one target audience in accordance with the scheduling of one or more electronic transmissions of the campaign media to the at least one user device associated with the at least one target audience.

In some embodiments, a computer system, including: a non-transient computer readable medium that stores computer executable instructions; at least one processor operably associated with the non-transient computer readable medium, wherein, when the at least one processor executes the computer executable instructions, the processor is configured to: obtain a campaign data structure related to campaign media; obtain audience data structures, wherein each of the audience data structures describes a corresponding audience of a plurality of audiences; based on the campaign data structure and the audience data structures, (1) select at least one target audience for the campaign media from the plurality of audiences, (2) determine at least one time slot for transmitting the campaign media to the selected target audience, and (3) determine at least one communication channel for transmitting the campaign media to the selected target audience; and schedule one or more electronic transmissions of the campaign media to at least one user device associated with the at least one target audience based on the campaign data structure and the audience data structures. In some embodiments, the at least one processor is configured to select the at least one target audience for the campaign media from the plurality of audiences based on the campaign data structure and the audience data structures by implementing a processing intelligence engine configured to associate the campaign data structure with the audience data structures so as to select the at least one target audience for the campaign media from the plurality of audiences. In some embodiments, the at least one processor is configured to implement the processing engine configured to associate the campaign data structure with the audience data structures by implementing k-clustering with the processing engine to associate the campaign data structure with the audience data structures. In some embodiments, the at least one processor is configured to select the at least one target audience for the campaign media from the plurality of audiences based on the campaign data structure and the audience data structures by: determining one or more audiences from the plurality of audiences that have received the campaign media more than a threshold number of times within a specified time period based on the audience data structures; flagging one or more audience data structures associated with the one or more audiences as being non-selectable so that the plurality of audiences minus the one or more audiences are a plurality of selectable audiences; selecting the at least one target audience for the campaign media from the plurality of selectable audiences. In some embodiments, the at least one processor is further configured to: obtain a second campaign data structure related to a second campaign media; based on the second campaign data structure and the audience data structures, (1) select at least one other target audience for the second campaign media from the plurality of audiences, (2) determine at least one other time slot for transmitting the second campaign media to the selected other target audience, and (3) determine at least one communication channel for transmitting the second campaign media to the selected other target audience; schedule one or more electronic transmissions of the second campaign media to at least one other user device associated with the at least one other target audience based on the second campaign data structure and the audience data structures. In some embodiments, the at least one processor is configured to determine the at least one time slot for transmitting the campaign media to the selected target audience and the at least one communication channel by: obtaining audience availability data that includes time availability data for the target audience from a one of the audience data structures related to the target audience; selecting time slots for the one or more electronic transmissions based on the time availability data and the campaign data structure; selecting one or more communication channels for transmission of the campaign media based on the campaign data structure and the one of the audience data structures and the campaign data structure. In some embodiments, the at least one processor is further configured to transmit the one or more electronic transmissions of the campaign media to the at least one user device associated with the at least one target audience in accordance with the scheduling of one or more electronic transmissions of the campaign media to the at least one user device associated with the at least one target audience.

In some embodiments, a non-transient computer readable medium that stores computer executable instructions, wherein, when the at least one processor executes the computer executable instructions, the processor is configured to: obtain a campaign data structure related to campaign media; obtain audience data structures, wherein each of the audience data structures describes a corresponding audience of a plurality of audiences; based on the campaign data structure and the audience data structures, (1) select at least one target audience for the campaign media from the plurality of audiences, (2) determine at least one time slot for transmitting the campaign media to the selected target audience, and (3) determine at least one communication channel for transmitting the campaign media to the selected target audience; and schedule one or more electronic transmissions of the campaign media to at least one user device associated with the at least one target audience based on the campaign data structure and the audience data structures. In some embodiments, the at least one processor is configured to select the at least one target audience for the campaign media from the plurality of audiences based on the campaign data structure and the audience data structures by implementing a processing engine configured to associate the campaign data structure with the audience data structures so as to select the at least one target audience for the campaign media from the plurality of audiences. In some embodiments, the at least one processor is configured to implement the processing engine configured to associate the campaign data structure with the audience data structures by implementing k-clustering with the processing engine to associate the campaign data structure with the audience data structures. In some embodiments, the at least one processor is configured to select the at least one target audience for the campaign media from the plurality of audiences based on the campaign data structure and the audience data structures by: determining one or more audiences from the plurality of audiences that have received the campaign media more than a threshold number of times within a specified time period based on the audience data structures; flagging one or more audience data structures associated with the one or more audiences as being non-selectable so that the plurality of audiences minus the one or more audiences are a plurality of selectable audiences; selecting the at least one target audience for the campaign media from the plurality of selectable audiences. In some embodiments, the at least one processor is configured to determine the at least one time slot for transmitting the campaign media to the selected target audience and the at least one communication channel by: obtaining audience availability data that includes time availability data for the target audience from a one of the audience data structures related to the target audience; selecting time slots for the one or more electronic transmissions based on the time availability data and the campaign data structure; selecting one or more communication channels for transmission of the campaign media based on the campaign data structure and the one of the audience data structures and the campaign data structure. In some embodiments, the at least one processor is further configured to transmit the one or more electronic transmissions of the campaign media to the at least one user device associated with the at least one target audience in accordance with the scheduling of one or more electronic transmissions of the campaign media to the at least one user device associated with the at least one target audience.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. A method, comprising:
obtaining, from a plurality of databases by a computer device, campaign data, wherein the campaign data from each of the plurality of databases has a different format;
obtaining, from the plurality of databases by a computer device, audience data from the plurality of databases, wherein the audience data from each of the plurality of databases has a different format;
converting, by the computer device, the campaign data from each of the plurality of databases to a campaign data structure having a standardized campaign database format, the campaign data structure being related to campaign media;
converting, by the computer device, the audience data from each of the plurality of databases to audience data structures having a standardized audience database format, wherein the audience data structures describe a corresponding audience of a plurality of audiences;
processing, by the computer device, the campaign data structure and the audience data structures (1) to determine at least one time slot and at least one communication channel providing a highest success rate for transmitting a first instance of the campaign media, and (2) to select at least one target audience, from the plurality of audiences, available at the determined at least one time slot and on the determined at least one communication channel providing the highest success rate for transmitting the first instance of the campaign media;
generating scheduling, by the computer device, a schedule for one or more electronic transmissions of determined information including the first instance of the campaign media, at the determined at least one time slot and on the determined at least one communication channel providing the highest success rate for transmitting the first instance of the campaign media, to at least one user device associated with the selected at least one target audience;
sending, by the computer device to an end user, the schedule and the determined information using the one or more electronic transmissions for review based on an approval procedure;
receiving, by the computer device, input from the end user regarding the approval procedure for the schedule and the determined information for the one or more electronic transmissions;
processing, by artificial intelligence (AI) engine of the computer device, the input from the end user regarding the approval procedure and the determined information to determine an accuracy of the schedule and the determined information for the one or more electronic transmissions to generate an approved schedule for the one or more electronic transmissions of approved information including an approved instance of campaign media, at least one time slot, at least one communication channel providing the highest success rate for transmitting the first instance of the campaign media, and at least one target audience; and
based on the approved schedule and the approved information, transmitting by the computer device campaign the approved information at the approved schedule.

2. The method of claim 1, wherein the selecting the at least one target audience, from the plurality of audiences, available at the determined at least one time slot and on the determined at least one communication channel providing the highest success rate for transmitting the first instance of the campaign media based on the processing of the campaign data structure and the audience data structures comprises implementing a processing engine configured to associate the campaign data structure with the audience data structures so as to select the at least one target audience, from the plurality of audiences, available at the determined at least one time slot and on the determined at least one communication channel providing the highest success rate for transmitting the first instance of the campaign media.

3. The method of claim 2, wherein the implementing the processing engine configured to associate the campaign data structure with the audience data structures comprises implementing k-clustering with the processing engine to associate the campaign data structure with the audience data structures.

4. The method of claim 1, wherein the processing the campaign data structure and the audience data structures to select the at least one target audience, from the plurality of audiences, available at the determined at least one time slot and on the determined at least one communication channel providing the highest success rate for transmitting the first instance of the campaign media based on the processing of the campaign data structure and the audience data structures comprises:
determining one or more audiences from the plurality of audiences that have received the first instance of the campaign media more than a threshold number of times within a specified time period based on the audience data structures;
flagging one or more audience data structures associated with the one or more audiences as being non-selectable so that the plurality of audiences minus the one or more audiences are a plurality of selectable audiences; and
selecting the at least one target audience, from the plurality of audiences, available at the determined at least one time slot and on the determined at least one communication channel providing the highest success rate for transmitting the first instance of the campaign media.

5. The method of claim 1, further comprising:
obtaining a second campaign data structure related to a second instance of the campaign media; and
processing the second campaign data structure and the audience data structures, (1) to select at least one other target audience for the second instance of the campaign media from the plurality of audiences, (2) to determine at least one other time slot for transmitting the second instance of the campaign media to the selected other target audience, and (3) to determine at least one second communication channel for transmitting the second instance of the campaign media to the selected other target audience.

6. The method of claim 1, wherein the processing the campaign data structure and the audience data structures to determine the at least one time slot and the at least one communication channel providing the highest success rate for transmitting the first instance of the campaign media comprises:
processing one of the audience data structures related to the available target audience to determine audience availability data that includes time availability data for the target audience on the at least one communication channel;
selecting time slots for the one or more electronic transmissions of the first instance of the campaign media based on the time availability data and the campaign data structure; and
selecting one or more communication channels for transmission of the first instance of the campaign media based on the campaign data structure and the one of the audience data structures.

7. The method of claim 1,
wherein the approved schedule and the approved information is different than the schedule and the determined information.

8. A computer system, comprising:
a non-transient computer readable medium that stores computer executable instructions;
at least one processor operably associated with the non-transient computer readable medium, wherein, when the at least one processor executes the computer executable instructions, the processor is configured to:
obtain campaign data from a plurality of sources, wherein the campaign data from each of the plurality of sources has a different format;
obtain audience data from the plurality of sources, wherein the audience data from each of the plurality of sources has a different format;
convert the campaign data from each of the plurality of sources to a campaign data structure having a standardized campaign database format, the campaign data structure being related to campaign media;
convert the audience data from each of the plurality of sources to audience data structures having a standardized audience database format, wherein the audience data structures describe a corresponding audience of a plurality of audiences;
process the campaign data structure and the audience data structures, (1) to determine at least one time slot and at least one communication channel providing a highest success rate for transmitting the first instance of the campaign media, and (2) to select at least one target audience, from the plurality of audiences, available at the determined at least one time slot and on the determined at least one communication channel providing the highest success rate for transmitting the first instance of the campaign media;
generate a schedule for one or more electronic transmissions of the first instance of determined information including the campaign media, at the determined at least one time slot and on the determined at least one communication channel providing the highest success rate for transmitting the first instance of the campaign media, to at least one user device associated with the selected at least one target audience;
send to an end user the schedule and the determined information using the one or more electronic transmissions for review based on an approval procedure;
receive input from the end user regarding the approval procedure for the schedule and the determined information for the one or more electronic transmissions;
implement an artificial intelligence (AI) engine, wherein the AI engine processes the input from the end user regarding the approval procedure and the determined information to determine an accuracy of the schedule and the determined information for the one or more electronic transmissions to generate an approved schedule for the one or more electronic transmissions of approved information including an approved instance of campaign media, at least one time slot, at least one communication channel providing the highest success rate for transmitting the first instance of the campaign media, and at least one target audience; and
based on the approved schedule and the approved information, transmit the approved information at the approved schedule.

9. The computer system of claim 8, wherein the at least one processor is configured to select the at least one target audience, from the plurality of audiences, available at the determined at least one time slot and on the determined at least one communication channel providing the highest success rate for transmitting the first instance of the campaign media based on the processing of the campaign data structure and the audience data structures by implementing a processing engine configured to associate the campaign data structure with the audience data structures so as to select the at least one target audience from the plurality of audiences available at the determined at least one time slot and on the determined at least one communication channel providing the highest success rate for transmitting the first instance of the campaign media.

10. The computer system of claim 9, wherein the at least one processor is configured to implement the processing engine configured to associate the campaign data structure with the audience data structures by implementing k-clustering with the processing engine to associate the campaign data structure with the audience data structures.

11. The computer system of claim 8, wherein the at least one processor is configured to select the at least one target audience, from the plurality of audiences, available at the determined at least one time slot and on the determined at least one communication channel providing the highest success rate for transmitting the first instance of the campaign media based on the processing of the campaign data structure and the audience data structures by:
determining one or more audiences from the plurality of audiences that have received the first instance of the campaign media more than a threshold number of times within a specified time period based on the audience data structures;
flagging one or more audience data structures associated with the one or more audiences as being non-selectable so that the plurality of audiences minus the one or more audiences are a plurality of selectable audiences; and
selecting the at least one target audience, from the plurality of audiences, available at the determined at least one time slot and on the determined at least one communication channel providing the highest success rate for transmitting the first instance of the campaign media.

12. The computer system of claim 8, wherein the at least one processor is further configured to:
obtain a second campaign data structure related to a second instance of the campaign media;
process the second campaign data structure and the audience data structures, (1) to select at least one other target audience for the second instance of the campaign media from the plurality of audiences, (2) to determine at least one other time slot for transmitting the second instance of the campaign media to the selected other target audience, and (3) to determine at least one second communication channel for transmitting the second instance of the campaign media to the selected other target audience; and
schedule one or more electronic transmissions of the second instance of the campaign media, at the determined at least one time slot and on the determined at least one second communication channel providing the highest success rate for transmitting the first instance of the campaign media, to the at least one other user device associated with the at least one selected other target audience.

13. The computer system of claim 8, wherein the at least one processor is configured to process the campaign data structure and the audience data structures to determine the at least one time slot and the at least one communication channel providing the highest success rate for transmitting the first instance of the campaign media by:
processing one of the audience data structures related to the target audience to determine audience availability data that includes time availability data for the target audience on the at least one communication channel;
selecting time slots for the one or more electronic transmissions of the first instance of the campaign media based on the time availability data and the campaign data structure; and
selecting one or more communication channels for transmission of the first instance of the campaign media based on the campaign data structure and the one of the audience data structures.

14. The computer system of claim 8, wherein
the approved schedule and the approved information is different than the schedule and the determined information.

15. A non-transient computer readable medium that stores computer executable instructions, wherein, when the at least one processor executes the computer executable instructions, the processor is configured to:
obtain campaign data from a plurality of sources, wherein the campaign data from each of the plurality of sources has a different format;
obtain audience data from a plurality of sources, wherein the audience data from each of the plurality of sources has a different format;
convert the campaign data from each of the plurality of sources to a campaign data structure having a standardized campaign database format, the campaign data structure being related to campaign media;
convert the audience data from each of the plurality of sources to audience data structures having a standardized audience database format, wherein the audience data structures describe a corresponding audience of a plurality of audiences;
process the campaign data structure and the audience data structures, (1) to determine at least one time slot and at least one communication channel providing a highest success rate for transmitting the first instance of the campaign media, and (2) to select at least one target audience, from the plurality of audiences, available at the determined at least one time slot and on the determined at least one communication channel providing the highest success rate for transmitting the first instance of the campaign media;
generate a schedule for one or more electronic transmissions of the first instance of determined information including the campaign media, at the determined at least one time slot and on the determined at least one communication channel providing the highest success rate for transmitting the first instance of the campaign media, to at least one user device associated with the selected at least one target audience;
send to an end user the schedule and the determined information using the one or more electronic transmissions for review based on an approval procedure;
receive input from the end user regarding the approval procedure for the schedule and the determined information for the one or more electronic transmissions;
process, by an artificial intelligence (AI) engine, the input from the end user regarding the approval procedure and the determined information to determine an accuracy of the schedule and the determined information for the one or more electronic transmissions to generate an approved schedule for the one or more electronic transmissions of approved information including an approved instance of campaign media, at least one time slot, at least one communication channel providing the highest success rate for transmitting the first instance of the campaign media, and at least one target audience; and
based on the approved schedule and the approved information, transmit the approved information at the approved schedule.

16. The non-transient computer readable medium of claim 15, wherein the at least one processor is configured to select the at least one target audience, from the plurality of audiences, available at the determined at least one time slot and on the determined at least one communication channel providing the highest success rate for transmitting the first instance of the campaign media based on the processing of the campaign data structure and the audience data structures by implementing a processing engine configured to associate the campaign data structure with the audience data structures so as to select the at least one target audience, available at the determined at least one time slot and on the determined at least one communication channel providing the highest success rate for transmitting the first instance of the campaign media.

17. The non-transient computer readable medium of claim 16, wherein the at least one processor is configured to implement the processing engine configured to associate the campaign data structure with the audience data structures by implementing k-clustering with the processing engine to associate the campaign data structure with the audience data structures.

18. The non-transient computer readable medium of claim 15, wherein the at least one processor is configured to select the at least one target audience, from the plurality of audiences, available at the determined at least one time slot and on the determined at least one communication channel providing the highest success rate for transmitting the first instance of the campaign media based on the processing of the campaign data structure and the audience data structures by:
determining one or more audiences from the plurality of audiences that have received the first instance of the campaign media more than a threshold number of times within a specified time period based on the audience data structures;
flagging one or more audience data structures associated with the one or more audiences as being non-selectable so that the plurality of audiences minus the one or more audiences are a plurality of selectable audiences; and
selecting the at least one target audience, from the plurality of audiences, available at the determined at least one time slot and on the determined at least one communication channel providing the highest success rate for transmitting the first instance of the campaign media.

19. The non-transient computer readable medium of claim 15, wherein the at least one processor is configured to process the campaign data structure and the audience data structures to determine the at least one time slot and the at least one communication channel providing the highest success rate for transmitting the first instance of the campaign media by:
processing one of the audience data structures related to the target audience to determine audience availability data that includes time availability data for the target audience on the at least one communication channel;
selecting time slots for the one or more electronic transmissions of the first instance of the campaign media based on the time availability data and the campaign data structure; and
selecting one or more communication channels for transmission of the first instance of the campaign media based on the campaign data structure and the one of the audience data structures.

20. The non-transient computer readable medium of claim 15, wherein
the approved schedule and the approved information is different than the schedule and the determined information.
